(19) United States
(12) Patent Application Publication
(10) Pub. No.: US 2021/0099785 A1
(43) Pub. Date: Apr. 1, 2021

(54) FITTED EARBUD COVERING

(71) Applicants: Kirt Alexander Abernathy, Nebo, NC (US); Tracie Dawn Abernathy, Morganton, NC (US)

(72) Inventors: Kirt Alexander Abernathy, Nebo, NC (US); Tracie Dawn Abernathy, Morganton, NC (US)

(21) Appl. No.: 16/948,634

(22) Filed: Sep. 25, 2020

Related U.S. Application Data
(60) Provisional application No. 62/907,084, filed on Sep. 27, 2019.

(51) Int. Cl. H04R 1/10

(52) U.S. Cl. CPC H04R 1/1016; H04R 1/1058

(57) ABSTRACT

An earbud covering for sheathing earbuds for preventing debris and bodily fluids, such as perspiration and earwax, from accumulating in the acoustic components (sound holes) of the earbud and/or unhygienically accumulating in the ear canal of the wearer. The earbud covering provides a meshed portion for covering the acoustic components and an elastic band for snugly engaging the non-acoustic portions of the earbud, such as the arm portion of the earbud, facilitating a comfortable and hygienic listening experience.

### CROSS-REFERENCE TO RELATED APPLICATION

This application claims the benefit of priority of U.S. provisional application No. 62/907,084, filed 27 Sep. 2019, the contents of which are herein incorporated by reference.

### BACKGROUND OF THE INVENTION

The present invention relates to speaker accessories and, more particularly, a fitted covering for an earphone, ear speaker, air pod device, or “earbud.” The fitted covering is adapted for protecting the acoustic components of the earbud as well as preventing unhygienic accumulation of bodily fluids and debris in the ear canal of the wearer.

Earbuds are very common these days due to the ubiquity of smart devices and other mobile computing devices. The earbuds are inserted into the ear and so tend to become covered in cerumen (“ear wax”), dirt, dust, perspiration, and the like. Such residue and debris can accumulate in the acoustic elements of the speakers, reducing the acoustic experience of the underlying speakers. Such debris and residue can also be difficult to clean when gathered in apertures associated with the acoustic elements. Furthermore, the non-absorbent material of current earbud designs channels perspiration into the ear canal which can create a skin irritation and ear infections as well as earwax build up in the ear canal.

Current earbuds focus on how their product looks and feels outside the ear and are not designed for what is happening on the inside the ear canal, such as the accumulation of bodily residue and debris in the ear canal and along some of the acoustic elements of the earbud. In other words, current earbud components and accessories are designed for ear comfort, sound quality, how the speaker sets on the outside of the ear, and of course how the earbuds look.

As can be seen, there is a need for a fitted earbud covering or sleeve for protecting the acoustic components of the earbud as well as preventing unhygienic accumulation of bodily fluids in the ear canal of the wearer. The earbud fitted fabric or earbud covering embodied in the present invention prevents accumulation of debris and residue in the acoustic components of the earbud while preventing such debris and residue from being packed into wearer's ear canal in an unhygienic manner. In short, the fitted ear speaker coverings provide a hygienic option that does not currently exist. The earbud covering fits over the ear speaker and is inserted along with the earbud into the ear canal, preventing ear contamination through absorbing and wicking perspiration from entering inside the ear canal without affecting the sound quality of the speakers or other acoustic components. The removable fitted earbud fabric can then be machine washed for cleaning and repeated use.

Put another way, current earbud manufacturers' designs help to hold the earbud in place by entering into the inner ear canal, creating a tight fit surrounding the earbud, while previous designs set loosely in the outer ear. This created the need for more friction at the point of the moment that held the weight of the ear bud for previous ear buds shaped like the letter ‘p’ where the weight of the ear bud set in the outer ear. The present invention is not intended for enhanced ear bud fitting, it is not part of a system kit, and does not intend to resolve the issues of lack of friction for the purpose of fitting. The manufacturers' have resolved this issue with the design that enters the inner ear canal for a tighter fit and to increase the leverage of the moment with the downward pull of the weight of the ear bud. The present invention is intended to resolve a different set of issues created by the earbud design that enters the inner ear canal—those related to hygiene and comfort that include repeated sanitary use with the ability to easily remove and machine wash the material, as disclosed herein.

### SUMMARY OF THE INVENTION

In one aspect of the present invention, an earbud covering includes the following: a head portion defining a hollow compartment configured to receive and snugly cover a head of an earbud; a sleeve portion defining a sleeve conduit in communication with the hollow compartment, wherein an opposing end of the sleeve conduit defines an open end; the head portion comprises a first material having capillary action properties relative to human perspiration, and wherein the first material comprises mesh; and the sleeve portion comprises an elastic material.

In another aspect of the present invention, a method of preventing debris and bodily fluids from accumulating in acoustic components of an earbud and in an ear canal of a wearer of the earbud, the method includes the following: providing the above-mentioned earbud covering; and sliding the head of the earbud through the open end and the sleeve conduit until the head of the earbud is snugly engaged by the hollow compartment in such a way that the open end is disposed outside of a concha associated with the ear canal when said earbud covering is worn.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a perspective view of exemplary embodiments of left and right earbuds of the present invention;

FIG. 3 is an exploded perspective view of an exemplary embodiment of the present invention;

FIG. 4 is a section view of an exemplary embodiment of the present invention, taken along line 4-4 in FIG. 1;

FIG. 5 is a detailed enlarged view of FIG. 4, illustrating how a covering prevents contamination, and thus promotes hygiene;

FIG. 6 is a perspective view of exemplary embodiments of left and right earbuds of the present invention shown in use; and

FIG. 7 is an exploded perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an earbud covering for sheathing earbuds for preventing debris and bodily fluids, such as perspiration and earwax, from accumulating in the acoustic components (sound holes) of the earbud and/or unhygienically accumulating in the ear canal of the wearer. The earbud covering provides a meshed portion for covering the acoustic components and an elastic band for snugly engaging the non-acoustic portions of the earbud, such as the arm portion of the earbud, facilitating a comfortable and hygienic listening experience.

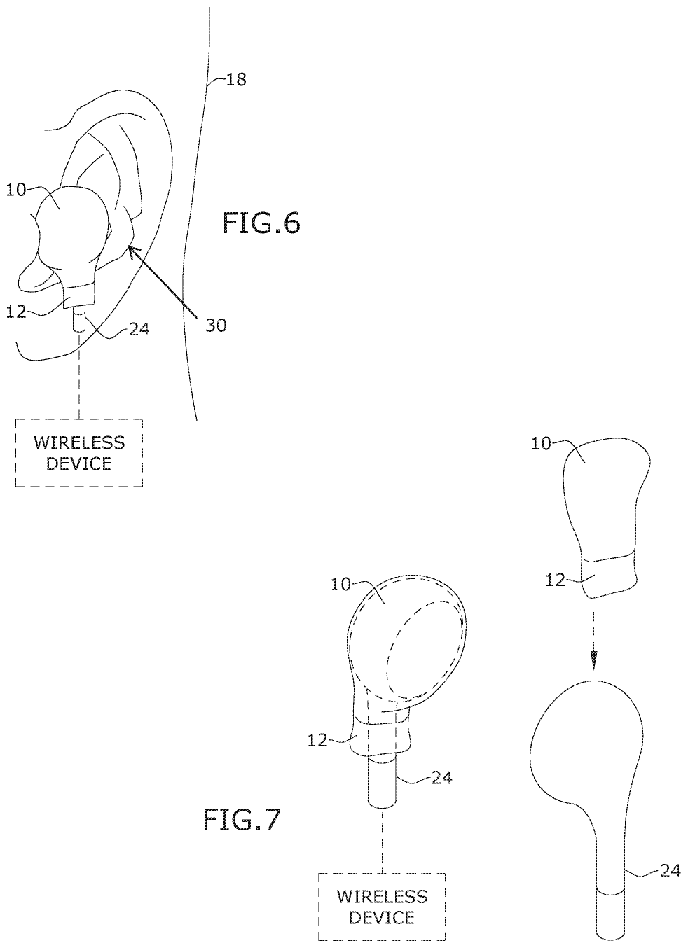

The outer ear 30 is the external portion of the ear and includes the fleshy visible pinna, the ear canal 20, and the outer layer of the eardrum (also called the tympanic membrane). The pinna consists of the curving outer rim called the helix, the inner curved rim called the antihelix and opens into the ear canal 20. The tragus protrudes and partially obscures the ear canal, as does the facing antitragus. The hollow region in front of the ear canal is called the concha 40, and the interface between the concha 40 and the ear canal 20 is where the earbud 14 is wedged into, as illustrated in FIGS. 1 and 4-6.

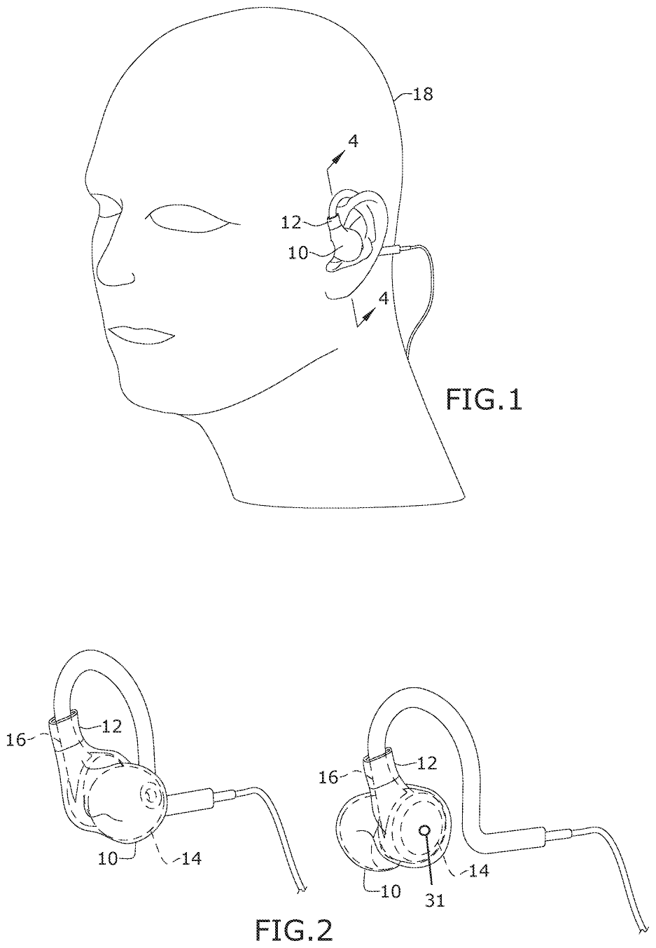

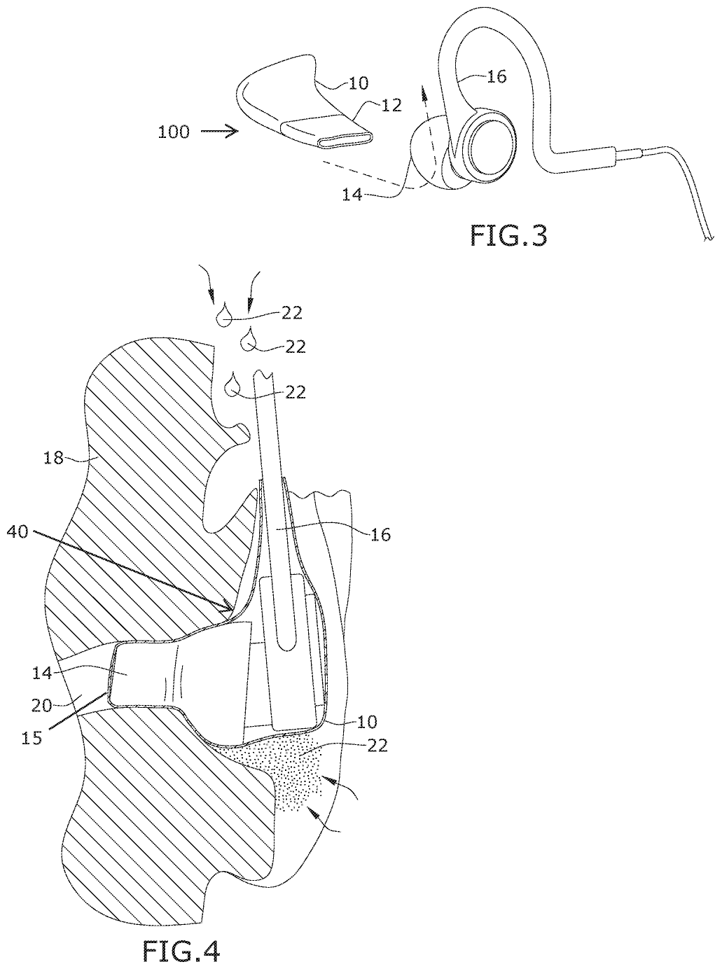

Referring now to FIGS. 1 through 7, the present invention may include an earbud covering 100 dimensioned and adapted or “fitted” to tightly encompass and engage the shape of the sheathed, operatively associated earbud 14. The earbud covering 100 may provide a first portion/zone 10 and second portion/zone 12, both portions/zones having any dimensions suitable to forming a “sock” covering for the earbud 14. Namely, the first portion 10 encompass the entirety of the bulbous portion (‘head’) of the earbud 14, while the second portion 12 covers the arm portion 16. The first portion 10 may define a head portion made from a first material, while the second portion 12 may be a sleeve made of a second, elastic material configured to cover the arm portion 16. In one embodiment, the head portion 10 defines a hollow compartment configured to receive and completely cover the head of the earbud 14, while the sleeve portion 12 defines a sleeve conduit in communication with the hollow compartment in which the sleeve conduit defines an open end. The open end allows passage of the head of the earbud 14 through the sleeve conduit and permits the arm portion 16 portion to be covered by the sleeve portion 12 once the earbud ‘head’ is fully disposed inside the hollow compartment.

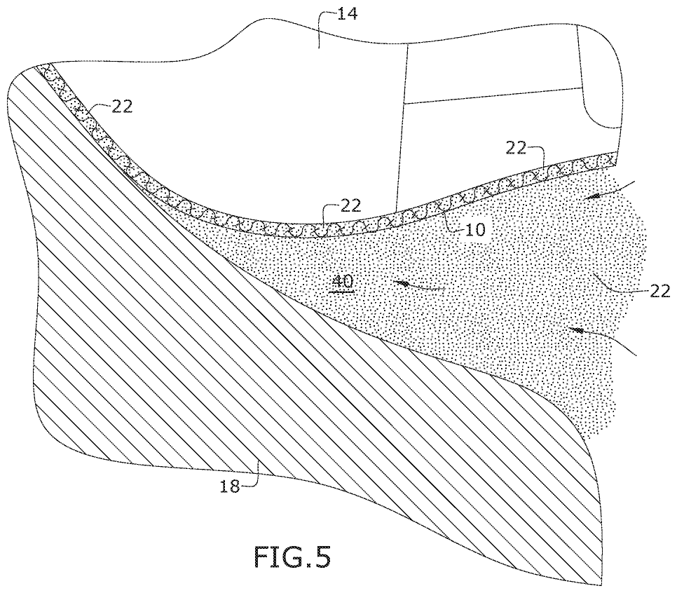

The first material may be made from any material capable of absorbing and wicking perspiration, by capillary action. The first material may be meshed or otherwise provide perforations for allowing sound waves therethrough in non-distorted or diminished manner. The second material may be an elastic material capable of elastically biasing the second portion 12 to snugly and frictionally engage said arm portion 16. The distal portion of the earbud head 14 provides the acoustic components and is directed into the ear canal 20, as illustrated in FIG. 4, which may be considered the ‘mouth’ 15 of the earbud ‘head’. Both first and second materials are durable and machine washable.

Specifically, the fitted wicking fabric of the first portion 10 may be a slim tight fit that will encompass the ear speaker and allow for comfort inside the ear canal 20 without affecting the sound quality of the speaker, while preventing debris and perspiration (“contamination” 22) from entering the ear canal 20. The fabric can be easily slipped on and off to allow for machine washing (i.e. similar to an athletic foot sock). The fitted earbud covering 100 can be produced with athletic type wicking fabric and knitted together similar to an athletic sock.

Additionally, the earbud covering 100 may be configured to accommodate the ability to use smart fabric for the purpose of controlling the earbud 14 (such as an air pod device) wherein the first material is a ‘smart fabric’ adapted to be compressed with a finger touch while the earbud 14 is inserted in the ear concha 40 to allow the smart fabric to communicate and control the earbud 14 device. In these embodiments, there may be a port 31 in the first fabric facing outward while using non-smart fabric that would allow for visual detection of hand jesters.

A method of using the present invention may include the following. The fitted earbud covering 100 disclosed above may be provided. The earbud covering 100 can be slipped on over any earbud 14, including a wireless earbud 24, that is designed to be inserted into the ear concha 40. An earbud covering 100 may be placed on both ear speakers and then inserted into the ear as designed by the manufacture of the ear speaker, wherein the additional thickness provided by the first material securely wedges at the concha 40 and ear canal interface, as illustrated in FIGS. 4 and 5, so that contamination cannot flow into the ear canal 20, which is sealed off entirely by the first material.

The capillary action of the first material urges fluid, such as human perspiration, radially away/outwardly athwart any inward urging of contamination (as illustrated by the arrows shown in FIGS. 4 and 5). Thereby, further deterring or preventing the buildup of contamination 22 in the ear canal 20.

After use, the earbud covering 100 can be removed and machine washable for cleaning.

It should be understood, of course, that the foregoing relates to exemplary embodiments of the invention and that modifications may be made without departing from the spirit and scope of the invention as set forth in the following claims.

What is claimed is:

1. An earbud covering comprising:
a head portion defining a hollow compartment configured to receive and completely cover a head of an earbud;
a sleeve portion defining a sleeve conduit in communication with the hollow compartment, wherein an opposing end of the sleeve conduit defines an open end;
the head portion comprises a first material having capillary action properties relative to human perspiration; and
the sleeve portion comprises an elastic material.

2. The earbud covering of claim 1, wherein the hollow compartment is dimensioned to snugly engage the head of the earbud.

3. The earbud covering of claim 1, further comprising a third material dimensioned and adapted to cover a mouth of the earbud, wherein the third material comprises mesh.

4. The earbud covering of claim 1, wherein the first material comprises mesh.

5. The earbud covering of claim 1, wherein the first material comprises a smart fabric configured to be compressed with a finger touch.

6. The earbud covering of claim 1, wherein the first material comprises a port, wherein the port is disposed along opposite a mouth of the earbud.

7. An earbud covering comprising:
a head portion defining a hollow compartment configured to receive and snugly cover a head of an earbud;
a sleeve portion defining a sleeve conduit in communication with the hollow compartment, wherein an opposing end of the sleeve conduit defines an open end;
the head portion comprises a first material having capillary action properties relative to human perspiration, and wherein the first material comprises mesh smart fabric; and
the sleeve portion comprises an elastic material.

8. The earbud covering of claim 7, wherein the first material comprises a port, wherein the port is disposed along opposite a mouth of the earbud.

9. A method of preventing debris and bodily fluids from accumulating in acoustic components of an earbud and in an ear canal of a wearer of the earbud, the method comprising:
providing the earbud covering of claim 5; and
sliding the head of the earbud through the open end and the sleeve conduit until the head of the earbud is snugly engaged by the hollow compartment in such a way that the open end is disposed outside of a concha associated with the ear canal when said earbud covering is worn.

10. The method of claim 6, further comprising machine washing said earbud covering after use.
